(19) United States
(12) Patent Application Publication
(10) Pub. No.: US 2017/0329879 A1
(43) Pub. Date: Nov. 16, 2017

(54) SYSTEM AND METHOD FOR MATERIAL CONSTITUTIVE MODELING

(71) Applicant: MultiMechanics, Inc., Omaha, NE (US)

(72) Inventors: Leandro Sales de Castro, Pella, IA (US); Flavio Vasconcelos de Souza, Omaha, NE (US)

(73) Assignee: MultiMechanics, Inc., Omaha, NE (US)

(21) Appl. No.: 15/591,491

(22) Filed: May 10, 2017

Related U.S. Application Data
(60) Provisional application No. 62/334,069, filed on May 10, 2016.

(51) Int. Cl. G06F 17/50

(52) U.S. Cl. CPC G06F 17/5009; G06F 17/5018; G06F 2217/16

(57) ABSTRACT

According to a preferred embodiment, the present invention provides a computing device and method to efficiently predict material behavior and to minimize the computational resources needed to obtain accurate simulations. According to a further preferred embodiment, the present invention tracks the history of driving variables for a section of a modeled element/object, for each material point or integration point or constitutive model. According to a further preferred embodiment, the present invention only maps unique histories of driving variables, within certain tolerance, to actual integration points' and/or constitutive models' data structure in order to optimize the amount of data needed to model the entire modeled element/object under determined boundary conditions. According to a further preferred embodiment, the present invention thereafter dynamically links the material response to each integration point and/or constitutive model in the modeled element/object. According to a further preferred embodiment, the present invention further balances the analysis work load across available computational resources to provide maximized performance. According to a further preferred embodiment, the present invention further reduces computational requirements through the use of databases to store/retrieve results obtained for a given history of driving variables and material definition.

### RELATED APPLICATIONS

The present application claims priority to U.S. Provisional Application No. 62/334,069 filed May 10, 2016.

### FIELD OF INVENTION

The present invention is related in general to computer modeling and, in particular, to a method for material constitutive modeling.

### BACKGROUND OF THE INVENTION

Constitutive models describe the physical properties of a given material. In physics and engineering, a constitutive equation or constitutive relation is a relation between two physical quantities (especially kinetic quantities as related to kinematic quantities) that are specific to a material or substance, and which approximate the response of that material to external stimuli, usually as applied fields or forces. In recent years, it has become increasingly common to use constitutive models to simulate the physical motion of a design model using a computer. These models have wide use in heat conduction analysis, fluid analysis, structural analysis, electromagnetic field analysis, electromagnetic wave analysis, and so forth.

To simulate physical models in a computer, a numerical method is required. Numerical methods for ordinary differential equations are methods used to find numerical approximations to the solutions of ordinary differential equations (ODEs). Among the various existing numerical methods, the Finite Element Method (FEM) and the Boundary Element method (BEM) are two of the most used.

In order to find numerical solutions to ODEs, numerical integration is often required. In numerical methods, numerical integration constitutes a broad family of algorithms for calculating the numerical value of a definite integral, and by extension, the term is also sometimes used to describe the numerical solution of differential equations. Numerical integration methods can generally be described as combining evaluations of the integrand to get an approximation to the integral. The integrand is evaluated at a finite set of points called integration points and a weighted sum of these values is used to approximate the integral. The integration points and weights depend on the specific method used and the accuracy required from the approximation.

In numerical scenarios, we refer to constitutive model as a data structure defining constants, variables and methods for calculating the constitutive behavior of materials, including, but not limited to linear and nonlinear material response and failure.

Along with an increase in their use, the object models to be analyzed have become increasingly complex. Further, the instances of applying multiple types of simulations to an object model have also increased. Additionally, current numerical methods and existing codes define one constitutive model for each and every integration point, meaning that all variables necessary to compute and store the material behavior are independently defined for each and every integration point. For large problems, this requires a lot of computing resources (i.e., memory, CPU processing time) because memory allocation and computations are unique for each and every integration point.

More recently, with the development of multiscale methods, where a sub-scale model is used to obtain the constitutive behavior of heterogeneous media, and therefore full models are nested to integration points, requirements for computing resources increased even further.

What is needed is a method which allows for calculating complex material behavior in large models without requiring substantial computing resources.

### SUMMARY OF THE INVENTION

The present invention overcomes the limitations of the prior art by providing tools and methods which reduce the number of calculations and amount of memory required for modeling material behavior. As discussed in detail below, the enhanced method of the present invention provides tools for defining, identifying, and processing data sets in a more efficient manner. The tools discussed below have resulted in significant and surprising improvements in processing accuracy and speed for a variety of computing tasks.

According to a preferred embodiment, the present invention provides a computing device and method to efficiently predict material behavior and to minimize the computational resources needed to obtain accurate simulations. According to a further preferred embodiment, the present invention tracks the history of specific driving variables (e.g., loading or deformation histories for structural analyses) at each material point or integration point or constitutive model, for a section of a modeled element/object, as a numerical solution progresses. According to a further preferred embodiment, the present invention only maps unique histories of driving variables, within certain tolerance(s), to actual integration points and/or constitutive model data structures in order to optimize the amount of data needed to model the entire modeled element/object under determined boundary conditions.

According to a first preferred aspect of the present invention, material points, integration points and/or constitutive model elements with the same history of driving variables (within certain tolerance(s)) are identified and processed in a related manner so that the amount of data required to satisfactorily model the physical problem may be minimized. According to a further preferred embodiment, the present invention thereafter dynamically links the material responses computed for each unique history of driving variables to each integration point and/or constitutive model in the modeled element/object. According to a further preferred embodiment, the present invention further balances the analysis work load across available computational resources, including multiple computers and/or multiple CPUs and/or multiple CPU cores and/or multiple computing threads and/or High Performance Computing (HPC) infrastructure, to provide maximized performance. The present invention is applicable to multiple numerical approaches, including, but not limited to the Finite Element Method and the Boundary Element Method. Other goals and advantages of the invention will be further appreciated and understood when considered in conjunction with the following description and accompanying drawings.

According to a further preferred embodiment of the present invention, computations related to each unique history of driving variables (within certain tolerance) may be performed in a local machine, in local or remote servers, or any other computing resource.

According to a further preferred embodiment of the present invention, computations related to each unique history of driving variables (within certain tolerance) of a material definition may be repeatedly performed, regardless whether the unique history of driving variables has been previously computed for the specific material definition in another distinct simulation job, related or not to the referred simulation job

According to a further preferred embodiment of the present invention, computations related to each unique history of driving variables (within certain tolerance) of a given material definition may be performed only once, in which case the material constitutive behavior for each unique history of driving variables may be stored in a database (local or remote) and may be retrieved in the future during the same or distinct simulation job, thus avoiding repeated computations and memory usage for the same unique history of driving variables (within certain tolerance).

According to a further preferred embodiment of the present invention, the material constitutive behavior resulting from computations related to each unique history of driving variables (within certain tolerance) of a given material definition may be stored/retrieved in a local or remote database during simulation of an object, part or physical model.

According to a further preferred embodiment of the present invention, the database with material constitutive behavior resulting from computations related to each unique history of driving variables (within certain tolerance) of a given material definition may be periodically or continuously expanded by applying different histories of the driving variables on a material definition, wherein these histories may be randomly or optimally defined by artificial intelligence.

While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### BRIEF DESCRIPTION OF THE DRAWINGS

Elements in the figures have not necessarily been drawn to scale in order to enhance their clarity and to improve the understanding of the various elements and embodiments of the invention. Furthermore, elements that are known to be common and well understood to those in the industry are not depicted in order to provide a clear view of the various embodiments of the invention. Thus, it should be understood that the drawings are generalized in form in the interest of clarity and conciseness.

FIG. 1 shows an exemplary computing system for use with the present invention.

FIG. 2 shows a flow chart of a preferred method of the present invention.

FIG. 3A shows an exemplary model for inputting into a system in accordance with one aspect of the present invention.

FIG. 3B shows an exemplary model which has been segmented in accordance with one aspect of the present invention.

FIG. 4 shows a further exemplary model which has been further process according to a further aspect of the present invention.

FIG. 5 shows a model Four-Point Bending Test processed according to one aspect of the present invention.

FIG. 6 shows a finite mesh element processed according to one aspect of the present invention.

FIG. 7 shows a chart illustrating the relationships between processed variables according to one aspect of the present invention.

### DETAILED DESCRIPTION

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below. In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

At least portions of the functionalities or processes described herein can be implemented in suitable computer-executable instructions. The computer-executable instructions may be stored as software code components or modules on one or more computer readable media (such as non-volatile memories, volatile memories, DASD arrays, magnetic tapes, floppy diskettes, hard drives, optical storage devices, etc. or any other appropriate computer-readable medium or storage device). In one embodiment, the computer-executable instructions may include lines of complied C++, Java, HTML, or any other programming or scripting code such as R, Python and/or Excel. Further, the present invention teaches the use of processors to perform the functionalities and processes described herein. As such, processor is understood to mean the computer chip or processing element that executes the computer code needed for the performance of a specific action.

Additionally, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

The terms “computer,” “engine,” “module,” “processor” and the like should be understood to be synonymous for the purposes of this disclosure. Additionally, any examples or illustrations given herein are not to be regarded in any way as restrictions on, limits to, or express definitions of, any term or terms with which they are utilized. Instead, these examples or illustrations are to be regarded as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms.

Reference is now made in detail to the exemplary embodiments of the invention, examples of which are illustrated in the accompanying drawings. Wherever possible, the same reference numbers will be used throughout the drawings to refer to the same or like parts. It should be understood that throughout this disclosure, unless logically required to be otherwise, where a process or method is shown or described, the steps of the method may be performed in any order or simultaneously. As used throughout this application, the word “may” is used in a permissive sense (i.e., meaning “having the potential to”), rather than the mandatory sense (i.e. meaning “must”).

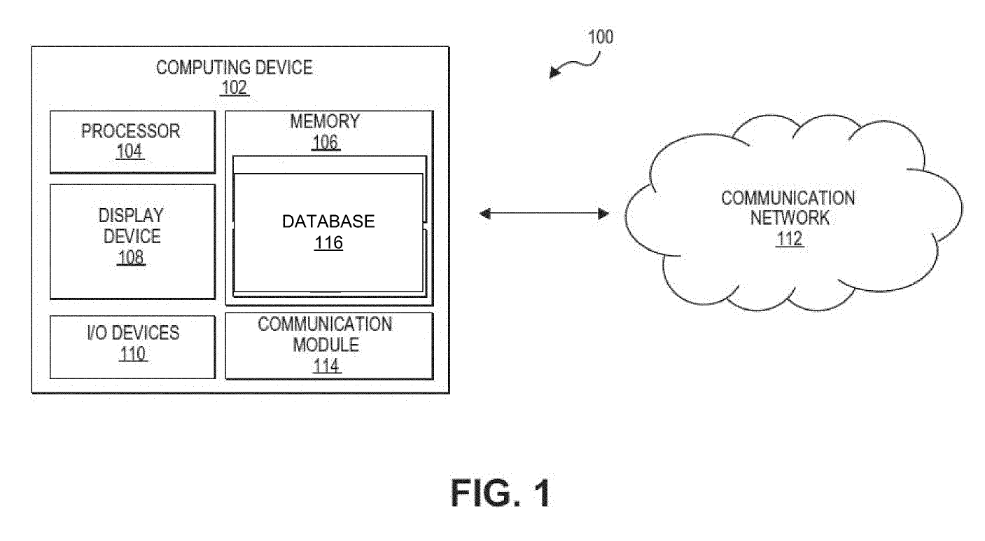

FIG. 1 illustrates a system 100 for analyzing, modeling and performing the steps of the present invention. As shown, the system 100 includes a computing device 102. In one or more implementations, the computing device 102 may be a server, a desktop computing device, a laptop computing device, or the like. As shown in FIG. 1, the computing device 102 includes a processor 104 and a memory 106 for storing data including database 116.

The processor 104 provides processing functionality for the computing device 102 and may include any number of processors, micro-controllers, or other processing systems and resident or external memory for storing data and other information accessed or generated by the computing device 102. The processor 104 may execute one or more software programs (e.g., modules) that implement techniques described herein.

The memory 106 is an example of tangible computer-readable media that provides storage functionality to store various data associated with the operation of the computing device 102, such as the software program and code segments mentioned above, or other data to instruct the processor 104 and other elements of the computing device 102 to perform the steps described herein.

The computing device 102 is also communicatively coupled to a display device 108 to display information to a user of the computing device 102. In embodiments, the display device 108 may comprise an LCD (Liquid Crystal Diode) display, a TFT (Thin Film Transistor) LCD display, an LEP (Light Emitting Polymer) or PLED (Polymer Light Emitting Diode) display, and so forth, configured to display text and/or graphical information such as a graphical user interface. For example, the display 108 displays visual output to the user. The visual output may include graphics, text, icons, video, interactive fields configured to receive input from a user, and any combination thereof (collectively termed “graphics”).

As shown in FIG. 1, the computing device 102 is also communicatively coupled to one or more input/output (I/O) devices 110 (e.g., a keyboard, buttons, a wireless input device, a thumbwheel input device, a touchscreen, and so on). The I/O devices 110 may also include one or more audio I/O devices, such as a microphone, speakers, and so on.

The computing device 102 is configured to communicate with one or more other computing devices over a communication network 112 through a communication module. The communication module 114 may be representative of a variety of communication components and functionality, including, but not limited to: one or more antennas; a browser; a transmitter and/or receiver (e.g., radio frequency circuitry); a wireless radio; data ports; software interfaces and drivers; networking interfaces; data processing components; and so forth.

The communication network 112 may comprise a variety of different types of networks and connections that are contemplated, including, but not limited to: the Internet; an intranet; a satellite network; a cellular network; a mobile data network; wired and/or wireless connections; and so forth.

Wireless networks may comprise any of a plurality of communications standards, protocols and technologies, including, but not limited to: Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11 g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS), and/or Short Message Service (SMS)), or any other suitable communication protocol.

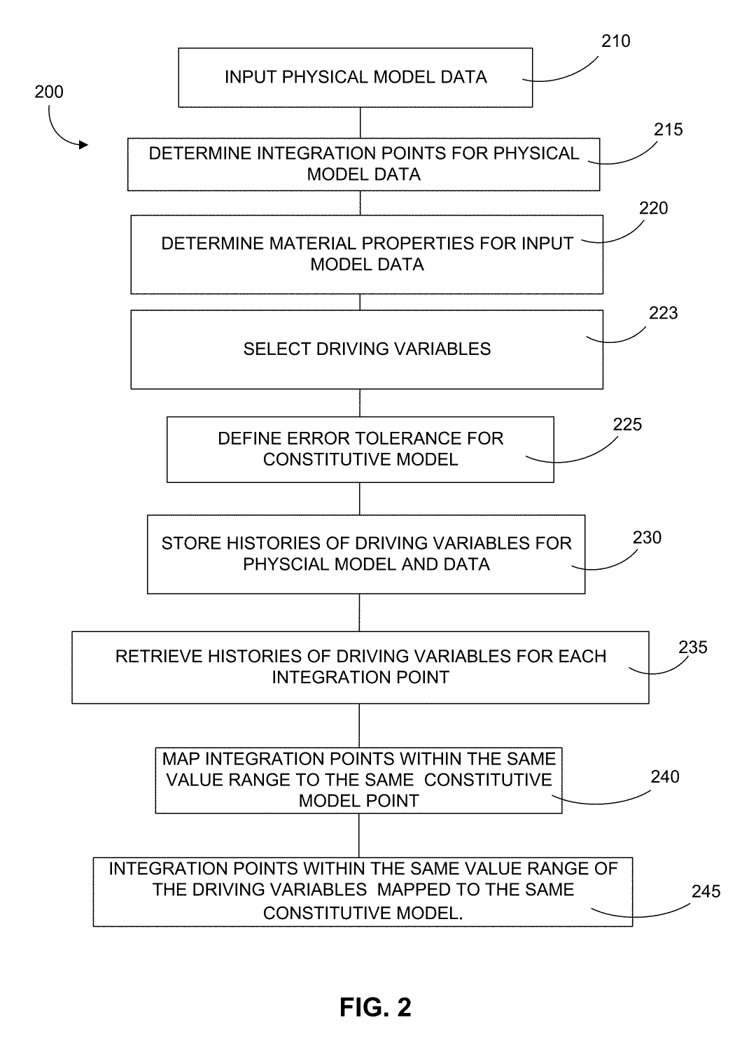

With reference now to FIGS. 2-4, an exemplary preferred method incorporating aspects of the present invention will now be discussed. Although the steps are provided in one particular order, it should be understood that the different steps may be performed in any particular order which logic allows. Further, different steps may occur. simultaneously.

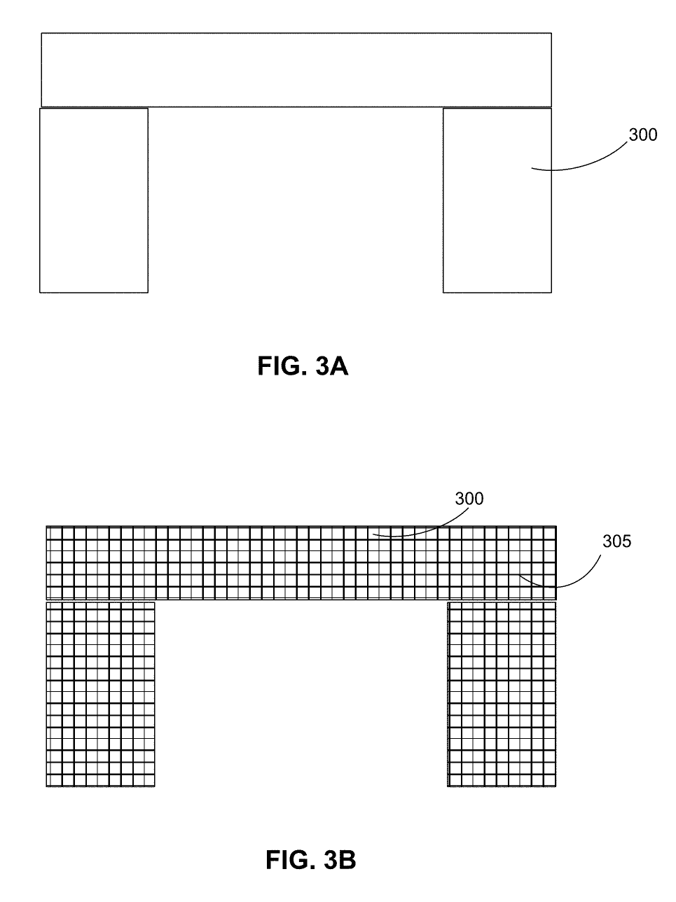

As shown in FIG. 2, an exemplary method 200 for modeling materials in accordance with a first preferred embodiment is provided. As shown, the exemplary method 200 preferably includes a first step 210 of inputting physical model data into the system. Preferably, the physical model data includes data defining the materials, elements and geometry of the physical model, as well as initial and boundary conditions. According to a prefer embodiment, physical model data may be defined for entry via a CAD system or the like with geometric elements of the physical data model defined directly or assembled using stored elements. An exemplary, simplified model 300 is shown in FIG. 3A.

Once the physical model data is entered and the initial model 300 is defined, a second step 215 is preferably performed which includes breaking the model 300 into a number of integration points for defining physical model data and performing numerical calculations. As shown in 3B, the integration points 305 preferably evenly cover the model and preferably include a sufficient number of integration points to fully define the elements of the physical model. Once the integration points are selected and defined, in step 220 the material properties for each integration point are preferably defined and stored. In step 223, driving variables are preferably selected. In accordance with a preferred embodiment, the driving variables selected are preferably determined based on the properties of selected materials and the forces applied to the materials. Since the material behavior is governed by a finite number of variables, preferably, less than two or three driving variables may be selected. According to a further preferred embodiment, the selection of a single tensor variable as the driving variable is optimal.

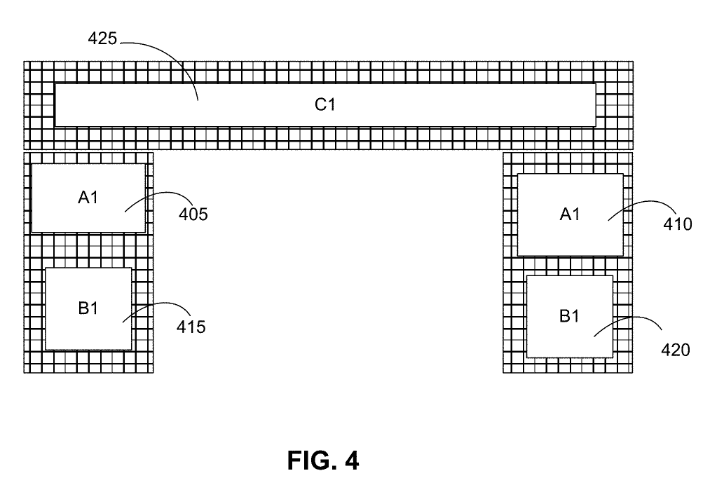

In step 225, an error tolerance is first selected for the specific constitutive model of the physical model. According to a preferred embodiment, the selected error tolerance may be different for each section, material or element of the physical model. With the error tolerance for the constitutive model defined, in step 230 the histories of the driving variable(s) for each defined material/integration point of the physical model are preferably calculated and stored. Thereafter, in step 235, the histories of driving variables for each defined integration point are preferably retrieved. In step 240, the driving variables for each defined integration point are then preferably grouped within the defined error tolerance(s). In step 245, the integration points within the same value range of the driving variables (i.e., same unique history of the driving variables within a selected error tolerance) are then preferably mapped to the same constitutive model. This process is shown in FIG. 4 in which each of the histories of the driving variables for defined integration points within selected areas A1 (405 and 410) have been grouped together for mapping based on their value ranges being within a defined error tolerance. Likewise, the histories of the driving variables for defined integration points within selected areas B1 (415 and 420) have been grouped together as well as the integration points within selected area C1 (425). In accordance with the present invention, if the history of driving variables (e.g., history of deformation) is exactly the same for multiple integration points, mapping multiple integration points to the same constitutive model will not introduce error to the solution. On the other hand, where the history of driving variables is not exactly the same, but within the defined tolerance, one may map all integration points that have approximately the same history of driving variables to the same constitutive model to obtain higher numerical efficiency at the cost of introducing acceptable errors to the solution.

Of course, this approach will be more efficient for constitutive models that require more memory to store variables and/or to perform more computations. In the case of TRUE Multiscale analyses, where the material constitutive behavior is determined by solving an additional IBVP at smaller length scales (microstructure), meaning that a full sub-scale model exists which is numerically solved to obtain the materials constitutive behavior, the gains in efficiency resulting from this approach are surprising and significant. In some cases, the present invention works to turn otherwise intractable large multiscale models into feasible and practical ones.

Accordingly, with the present invention, one can map a unique material constitutive model to a unique history of the driving variable(s). Further in accordance with the present invention, in numerical scenarios, unique histories of the driving variables can be defined within acceptable numerical tolerance(s), to obtain a finite set of unique histories. The larger the tolerance, the finite set of histories will have less unique entries. In other words, more efficiency is gained at the cost of larger errors. In most practical problems, the gain in efficiency is order of magnitudes higher than the error resulting from the approximation in the finite set of histories. In mechanical/structural models, for example, stresses are assumed to be a function of the entire history of deformation, as mathematically described by the equation below. In this case, a strain measure, εₖₗ, which can be infinitesimal or finite, and its time and/or spatial derivatives may be used to define deformation in a material point

σᵢⱼ(xₚ,t)=Π_{t=-∞}^{∞}[εₖₗ(xₚ,t),εₖₗ′(xₚ,t), . . . ]

According to a preferred embodiment, deformation is a preferred choice of driving variable for such structural material constitutive models. According to a further preferred embodiment, the temperature gradient is a preferred choice of driving variable for such thermal material constitutive models.

In accordance with a still further preferred embodiment of the present invention, an exemplary process and algorithm is provided below:

Exemplary Algorithm/Workflow

| | |
|---|---|
| 1. | Initialization |

| | |
|---|---|
| a. | For each material in the model, create only one constitutive model |

| | |
|---|---|
| i. | Each constitutive model contains a map data structure that links |
| | current strain, [Strain], in local/material coordinate system, to |
| | possibly branched/cloned constitutive models. Refer to this map |
| | as [branchesMap] |

| | |
|---|---|
| b. | For each element with same material, assign the constitutive model |
| | created in previous step to all of its integration points |

| | |
|---|---|
| 2. | For each time increment |

| | |
|---|---|
| a. | For each integration point mapped to unique history of strain, preferably |
| | with history-dependent constitutive behavior |

| | |
|---|---|
| i. | Compute the current mechanical strain (driving variable), |
| | [Strain], in local/material coordinate system |
| ii. | Update [branchesMap] |

| | |
|---|---|
| b. | For each integration point, preferably with history-dependent constitutive |
| | behavior, excluding those already mapped to a unique history of strain |

| | |
|---|---|
| i. | Branch-off constitutive models that deviate from mapped unique |
| | strain histories, if any, given [Strain] |

| | |
|---|---|
| 1. | If [Strain] is mapped in the integration point's constitutive |
| | model |

| | |
|---|---|
| a. | Use the constitutive model corresponding to |
| | [Strain] |

| | |
|---|---|
| 2. | Else |

| | |
|---|---|
| a. | Clone current constitutive model |
| b. | Map [Strain] to cloned constitutive model |
| c. | Assign cloned constitutive model to the current |
| | integration point |

As would be well understood to those of ordinary skill in the art, the algorithm/workflow described above primarily provides the steps of the present invention that are unique to this invention. Accordingly, some steps are omitted for better description of the invention's unique key points.

By use of the exemplary algorithm/workflow provided above, new constitutive models may be automatically created when the history of a given driving variable (i.e. total strain) deviates from existing ones, thus minimizing the number of unique constitutive models. In this way, the present invention minimizes memory requirements and maximizes the speed of the solution since computations in the unique constitutive models are not repeated.

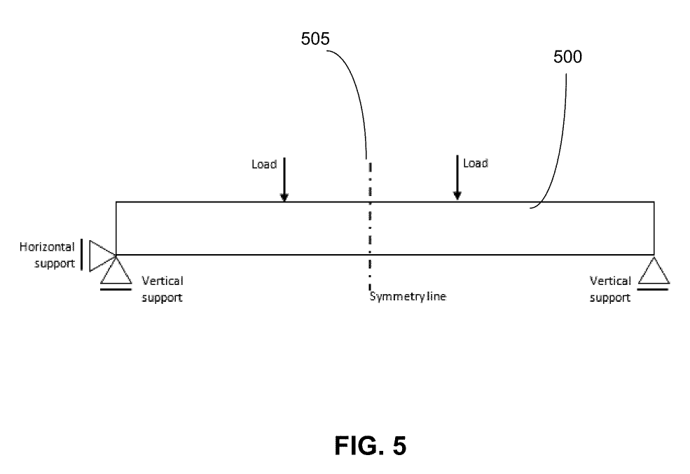

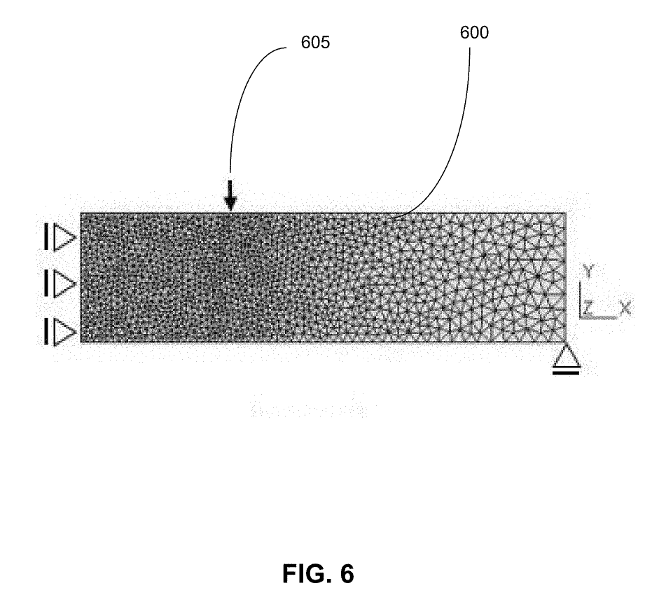

With reference now to FIGS. 5 and 6, a further process illustrating aspects of the present invention will now be discussed. As shown in FIG. 5, a Four-Point Bending Test is depicted for a beam 500. According to aspects of the present invention, due to symmetry conditions, only half of the model needs to be modeled with the model split along symmetry line 505. Preferably, in this particular example, damage is allowed to initiate and grow in each and every unique constitutive model, and is modeled via the continuum damage approach where damage is represented by a scalar state variable that modifies the material's constitutive tensor. In this specific example, the damage state variable is defined in terms of the components of the strain tensor. Loads are increased incrementally until the specimen fails. According to aspects of the present invention, a full finite element model may preferably be used to extract the constitutive behavior of the material's micro-structure, in a concurrent multiscale simulation.

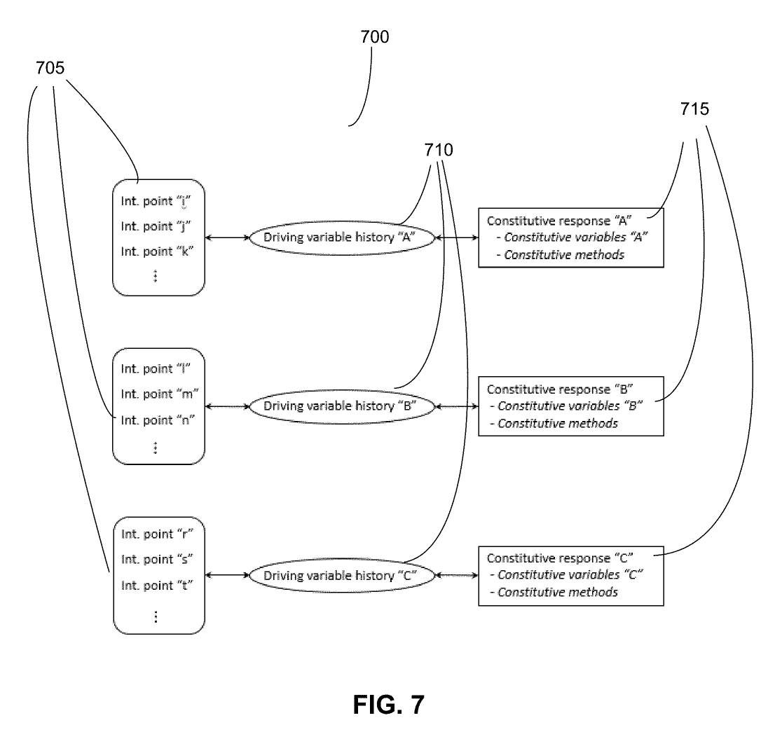

With reference now to FIG. 6, a finite element mesh is provided for processing in accordance with a further aspect of the present invention. As shown, the finite element mesh 600 contains 2567 triangle elements and 2567 integration points. According to the example of FIG. 6, the tolerance for differentiating unique strains at each solution/time step (history of strain) is approximately 10⁻⁴. According to the present invention, a set of driving variables are selected and processed from these integration points in response to a point load 605 as discussed with respect to FIG. 7 below.

With reference now to FIG. 7, an exemplary chart 700 is provided which illustrates the relationships between a range of integration points 705, driving variables 710 and constitutive variables 715. As shown, constitutive variables “A” are shared among integration points “i”, “j”, “k”, . . . ; and constitutive methods/functions for constitutive response “A” are uniquely called for driving variable history “A”, not for each and every integration point. According to a further preferred embodiment, this process is then repeated for other histories of selected driving variables to produce a single model for an entire structure. In this way, the present invention minimizes computer memory usage and reduces the time required to solve any given problem.

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

What is claimed is:

1. A computer program product for use in a network connectable system which includes one or more client systems running application that may receive data from remote data sources, the computer program product comprising one or more computer readable storage media having encoded thereon computer executable instructions which, when executed upon one or more computer processors, performs a method for supplying modified data to a requesting application, the method comprising:
inputting physical model data into a system to define an initial physical model, wherein the physical model data includes data defining the materials, elements and geometry of a physical model;
grouping the physical model data into a number of selected integration points for defining physical model data;
defining and storing material properties for each integration point;
selecting driving variables for defined constitutive models for each integration point;
selecting an error tolerance;
calculating and storing the histories of the driving variables for each defined integration point of the physical model;
retrieving the histories of driving variables for each defined integration point;
grouping the driving variables based on the defined error tolerance, and defining unique histories of the driving variables within the error tolerance; and
mapping integration points with the same material definition and within the same value range of the driving variables and within the error tolerance to the same constitutive model.

2. The method of claim 1, wherein the integration points evenly cover the physical model.

3. The method of claim 2, wherein the integration points evenly cover a plurality of elements of the physical model.

4. The method of claim 3, wherein the method further includes the step of defining and storing each integration point.

5. The method of claim 4, wherein at least one driving variable is determined at least in part from the properties of the material of the physical model.

6. The method of claim 5, wherein at least one driving variable is determined at least in part based on the forces applied to the physical model.

7. The method of claim 6, wherein less than three driving variables are selected.

8. The method of claim 7, wherein at least one driving variable selected is a single tensor variable.

9. The method of claim 8, wherein the selected error tolerance is different for each element of the physical model.

10. The method of claim 9, wherein the selected error tolerance is the same for elements of the physical model with same material definition.

11. The method of claim 10, wherein the driving variable represents deformation for a mechanical material constitutive model.

12. The method of claim 11, wherein the driving variable represents a temperature gradient for a thermal material constitutive model.

13. The method of claim 12, wherein a line of symmetry is selected for the physical model and integration points from only one side of the physical model are selected for processing.

14. The method of claim 13, wherein a damage state variable is selected as the driving variable.

15. The method of claim 14, wherein the constitutive behavior is modeled using a continuum damage approach, wherein damage is represented by a scalar state variable that modifies a selected material's constitutive tensor.

16. The method of claim 15, wherein damage is modeled by explicit cracks or cohesive zone elements, which may be inserted in the finite element mesh, or inserted automatically during analysis.

17. The method of claim 16, wherein computations related to each unique history of driving variables are performed in local machines or in local or remote servers.

18. The method of claim 17, wherein computations related to each unique history of driving variables of a material definition are repeatedly performed for different simulation jobs.

19. The method of claim 18, wherein computations related to each unique history of driving variables of a specific material definition are performed only once, stored in a local or remote database and retrieved in the future during the same or distinct simulation job.

20. The method of claim 19, wherein, given a material definition, the database is periodically expanded or updated by applying different histories of the driving variables, wherein these histories are defined by artificial intelligence.
